(19) United States
(12) Patent Application Publication
(10) Pub. No.: US 2005/0228089 A1
(43) Pub. Date: Oct. 13, 2005

(54) Lubricant for treating elastic fiber

(76) Inventors: Ikunori Azuse, Kyoto-shi (JP); Yoshiyuki Wakahara, Kyoto-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/505,748

(22) PCT Filed: Feb. 28, 2003
(86) PCT No.: PCT/JP03/02290

§ 371 Date: May 12, 2005

(30) Foreign Application Priority Data
Feb. 28, 2002 (JP) 2002-545576

(51) Int. Cl. C08L 1/00

(52) U.S. Cl. 524/173

(57) ABSTRACT

The present invention provides a lubricant for treating elastic fiber which comprises
at least 80 mass % of at least one base oil (A) having a viscosity at 25° C. of 1 to 1,000 mm²/s as selected from the group consisting of silicone oil (A1) and hydrocarbon series lubricating oil (A2), 0.05 to 2 mass % of a C12 to 24 higher fatty acid alkaline earth metal salt (B) having a volume average particle diameter of 0.001 to 1 μm, and 0.01 to 8 mass % of at least one surfactant (C) having a solubility parameter (SP value) of 8.0 to 10.5 as selected from the group consisting of anionic surfactant (C1) and nonionic surfactant (C2).

### TECHNICAL FIELD

The present invention relates to a lubricant for treating elastic fiber. More particularly, the invention relates to a lubricant for obtaining an elastic fiber having a satisfactory anti-tackiness characteristic.

### BACKGROUND ART

It has heretofore been proposed to suspend a finely divided solid metal soap in the lubricant to be deposited on fiber as an anti-tackiness agent in elastic fiber spinning processes to thereby cause expression of a release effect (Japanese Kokoku Publication Sho-41-286 and Japanese Kokoku Publication Sho-40-5557).

Although the above technology provides for an anti-tackiness effect, the solid component added is so poor in dispersion stability that it undergoes aggregation and sedimentation with time, with the result that, when such a lubricant is used, uneven deposition on the fiber occurs to prevent expression of a uniform anti-tackiness effect and, in a subsequent processing stage, a variation in tension, for instance, tends to cause troubles such as broken filaments.

### SUMMARY OF THE INVENTION

It is, therefore, an object of the present invention is to provide a lubricant for treating elastic fiber which has a long-term stability and, in the manufacture of elastic fiber, exhibits an excellent preventive effect against filament-to-filament tackiness.

After an intensive investigation for the development of such a lubricant as above, the inventors of the present invention found that the above disadvantages can be overcome by using a lubricant containing a higher fatty acid metal salt with its volume average particle diameter controlled within a defined range and a surfactant having a defined solubility parameter. The inventors have accordingly developed the present invention.

The present invention, therefore, is directed to
a lubricant for treating elastic fiber
which comprises
at least 80 mass % of at least one base oil (A) having a viscosity at 25° C. of 1 to 1,000 mm²/s as selected from the group consisting of silicone oil (A1) and hydrocarbon series lubricating oil (A2),
0.05 to 2 mass % of a C12 to 24 higher fatty acid alkaline earth metal salt (B) having a volume average particle diameter of 0.001 to 1 μm, and
0.01 to 8 mass % of at least one surfactant (C) having a solubility parameter (SP value) of 8.0 to 10.5 as selected from the group consisting of anionic surfactant (C1) and nonionic surfactant (C2);
a method of treating elastic fiber
which comprises applying 0.1 to 12 mass % of said lubricant for treating elastic fiber to elastic fiber in its spinning stage, optionally followed by scouring; and
an elastic fiber
which is treated by the above method.

### DETAILED DESCRIPTION OF THE INVENTION

The present invention is now described in detail.

The base oil (A) for use in the present invention is a base oil selected from the group consisting of silicone oil (A1) and hydrocarbon series lubricating oil (A2) and having a viscosity at 25° C. of 1 to 1,000 mm²/s. The lower limit of viscosity at 25° C. of said base oil (A) is preferably 2 mm²/s, more preferably 3 mm²/s. The upper limit is preferably 100 mm²/s, more preferably 50 mm²/s.

The viscosity can be measured as follows.

The base oil (A) is placed in a 20 g Ubbelohde viscometer and its temperature is adjusted to 25±0.5° C. in a constant-temperature water bath. After 30 minutes, the viscosity of the sample is measured with the Ubbelohde viscometer.

The silicone oil (A1) which can be used in the invention is not particularly restricted but there may be mentioned, for example, those unsubstituted polydimethylsiloxanes and substituted polydimethylsiloxanes as substituted by a group or groups selected from the group consisting of alkyl groups containing 2 to 20 carbon atoms and phenyl group, whose viscosities at 25° C. are 1 to 1,000 mm²/s.

The preferred, among these, are polydimethylsiloxanes having viscosities at 25° C. of 2 to 100 mm²/s, with those having viscosities of 3 to 50 mm²/s being more preferred.

The hydrocarbon series lubricating oil (A2) which can be used in the invention is not particularly restricted but may for example be a mineral oil or a purified, hydrogenated, or cracked mineral oil, whose viscosity at 25° C. is 1 to 1,000 mm²/s. The mineral oil mentioned above is not particularly restricted but there may be mentioned liquid paraffin, for instance.

The preferred, among these, are the mineral oil and purified mineral oil whose viscosity at 25° C. is 2 to 100 mm²/s, more preferably 3 to 50 mm²/s.

The base oil (A) to be used may be a single species of oil or a mixture of two or more different species. Furthermore, either (A1) alone or (A2) alone may be used or a mixture of (A1) and (A2) may be used. The preferred is (A2) alone or a mixture of (A1) and (A2), with a mixture of (A1) and (A2) being still more preferred.

In the case of said mixture, the lower limit of (A1)/(A2) ratio (mass ratio) is preferably 80/20, more preferably 70/30, still more preferably 65/35. The upper limit is preferably 5/95, more preferably 10/90, still more preferably 15/85.

From anti-tackiness and smoothing points of view, the proportion of the base oil (A) in the lubricant of the invention is generally not less than 80 mass %, preferably not less than 82 mass %, more preferably not less than 85 mass %. The upper limit is preferably 9.9.9 mass %, more preferably 99 mass %.

The higher fatty acid of said higher fatty acid alkaline earth metal salt (B) to be formulated in the lubricant for treating elastic fiber according to the invention is a higher fatty acid containing 12 to 24 carbon atoms.

The higher fatty acid mentioned above is not particularly restricted but, there may be mentioned, for example, lauric acid, myristic acid, palmitic acid, stearic acid, isostearic acid, and behenic acid, all of which have 12 to 24 carbon atoms. The preferred, among these, are palmitic acid, stearic acid and behenic acid, all of which have 16 to 22 carbon atoms, with stearic acid being particularly preferred.

The alkaline earth metal salt is not particularly restricted but there may be mentioned, for example, barium salts, calcium salts, and magnesium salts, with magnesium salts being preferred.

The higher fatty acid alkaline earth metal salt (B) is not particularly restricted but there may be mentioned, for example, magnesium dilaurate, calcium dilaurate, barium dilaurate; magnesium dimyristate, calcium dimyristate, barium dimyristate; magnesium dipalmitate, calcium dipalmitate, barium dipalmitate; magnesium distearate, calcium distearate, barium distearate; magnesium diisostearate, calcium diisostearate, barium diisostearate; magnesium dibehenate, calcium dibehenate, barium dibehenate; magnesium palmitate stearate, calcium palmitate stearate and barium palmitate stearate. The preferred, among these, are alkaline earth metal salts of stearic acid, with magnesium distearae being particularly preferred. Commercial salts, such as magnesium distearate containing somewhat an unreacted magnesium hydroxystearate as an impurity, can also be used likewise.

These higher fatty acid alkaline earth metal salts (B) can be used either independently or in a combination of 2 or more different species.

The level of use of the higher fatty acid alkaline earth metal salt (B) in the lubricant of the invention is generally 0.05 to 2 mass %, the preferred lower limit being 0.2 mass % and the preferred upper limit being 1.8 mass %. With a proportion of 0.05 mass % or larger, a good anti-tackiness effect can be obtained. If the level of use is not over 2 mass %, the whole lubricant will not undergo any significant viscosity build-up with time so that filament breakage and other troubles will not take place even when the fineness of the filaments spun is as fine as 11 to 22 decitex (dtx) and the like.

The volume average particle diameter of the higher fatty acid alkaline earth metal salt (B) dispersed in the lubricant of the invention is generally controlled within the range of 0.001 to 1 μm from lubricant stability and anti-tackiness points of view. The lower limit of volume average particle diameter of the alkaline earth metal salt (B) is preferably 0.01 μm, more preferably 0.1 μm. The preferred upper limit is 0.5 μm. If the diameter is less than 0.001 μm, the anti-tackiness effect will be insufficient. If it exceeds 1 μm, the stability of the lubricant will be adversely affected.

The volume average particle diameter is measured by the dynamic light scattering method. More particularly, the lubricant is placed in a 10 mm-long cell and the volume average particle diameter is measured with a particle size analyzer.

The surfactant (C) for use in the present invention is one having a solubility parameter (hereinafter referred to sometimes briefly as SP value) of 8.0 to 10.5. The preferred lower limit of solubility parameter of the surfactant (C) is 8.1. The upper limit is preferably 10.2, more preferably 9.9. If the SP value is less than 8.0, the compatibility with the higher fatty acid alkaline earth metal salt (B) will be poor and the stability of the lubricant will also be insufficient. Exceeding 10.5 leads to poor compatibility with the base oil (A), rendering the lubricant rather unstable.

The “solubility parameter” as the term is used herein is expressed in the square root of the ratio of cohesive energy density to molecular volume, as follows.
[Solubility parameter]=(ΔE/V)^{1/2}
In the formula, ΔE stands for coherent energy density and V stands for molecular volume, the value of which is as calculated by the method of Robert F. Fedors et al as described in, for example, Polymer Engineering and Science, 14, 147-154 (1974).

The surfactant (C) for use in the present invention is a surfactant selected from the group consisting of anionic surfactant (C1) and nonionic surfactant (C2) and having an SP value within the above-mentioned range.

The anionic surfactant (C1) is not particularly restricted but the sulfosuccinic ester anionic surfactant (C1-1) represented by the following general formula (1) and the ethercarboxylic acid anionic surfactant (C1-2) represented by the following general formula (2), among others, are preferred.

The sulfosuccinic ester anionic surfactant (C1-1) which can be used in the invention is represented by the following general formula (1).

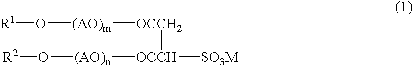

In the above general formula (1), R¹ and R² each independently represents an alkyl group containing 1 to 24 carbon atoms or an alkenyl group containing 2 to 24 carbon atoms.

The alkyl group containing 1 to 24 carbon atoms may be whichever of a straight-chain group and a branched chain group, and there may be mentioned, for example, a methyl, ethyl, n- and i-propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, and 2-ethyldecyl groups.

The alkenyl group containing 2 to 24 carbon atoms may be whichever of a straight-chain group or a branched-chain group, and there may be mentioned, for example, an n- and i-propenyl, hexenyl, heptenyl, octenyl, decenyl, undecenyl, dodecenyl, tetradecenyl, pentadecenyl, hexadecenyl, heptadecenyl, octadecenyl, nonadecenyl, and 2-ethyldecenyl groups.

The preferred examples of R¹ and R² are alkyl groups of 3 to 24 carbon atoms. These may each be a mixture of two or more different species.

In the general formula (1), A represents an alkylene group containing 2 to 4 carbon atoms, including an ethylene, propylene, and butylene groups. The preferred, among these, are ethylene and propylene groups. A may be a mixture of two or more different species. In the case of a mixture, it may be whichever of a random one and a block one.

In the general formula (1), m, n, and m+n each respectively represents an integer of 0 to 10, preferably an integer of 0 to 6, more preferably an integer of 0 to 3. Exceeding 10 tends to adversely affect the compatibility with the base oil (A).

In the general formula (1), M represents a hydrogen atom, an alkali metal atom e.g lithium, potassium, sodium), or a substituted or unsubstituted ammonium (e.g. monoethanolammonium, diethanolammonium, triethanolammonium, 2-ethylhexylammonium) group. The preferred, among these, is an alkali metal atom. It may be a mixture of two or more species.

The sulfosuccinic ester anionic surfactant (C1-1) represented by the general formula (1) is not particularly restricted but there may be mentioned, for example, di-2-ethylhexyl sulfosuccinate sodium, palmityl stearyl sulfosuccinate potassium, and polyoxyethylene-di-2-ethylhexyl sulfosuccinate sodium (6 mol EO adduct; m=n=3).

The ethercarboxylic acid anionic surfactant (C1-2) for use in the invention can be represented by the following general formula (2).
R³—O-(AO)ₚ-CH₂COOM (2)

Referring to the general formula (2), specific examples and preferred examples of R³ are the same as those mentioned above for R¹ and R².

In the general formula (2), A and M are respectively the same as those in general formula (1).

In the general formula (2), p represents an integer of 0 to 10, preferably 1 to 6. Exceeding 10 tends to adversely affect the compatibility with the base oil.

The ethercarboxylic acid anionic surfactant (C1-2) represented by general formula (2) is not particularly restricted but there may be mentioned, for example, octyl alcohol carboxymethyl ether sodium salt, decyl alcohol carboxymethyl ether sodium salt, lauryl alcohol carboxymethyl ether sodium salt, Dobanol 23 carboxymethyl ether sodium salt, tridecanol carboxymethyl ether sodium salt, octyl alcohol-EO(3 mol) adduct carboxymethyl ether sodium salt, lauryl alcohol-EO(4 mol) adduct carboxymethyl ether sodium salt, isotridecyl alcohol-EO(3 mol) adduct carboxymethyl ether sodium salt, Dobanol 23-EO(3 mol) adduct carboxymethyl ether sodium salt, and tridecanol-EO(5 mol) adduct carboxymethyl ether sodium salt.

As the preferred specific examples, there can be mentioned sodium octyl-etherified acetate, sodium decyl-etherified acetate, sodium lauryl-etherified acetate, sodium tridecyl-etherified acetate, sodium polyoxyethylene (EO 3 mol) octyl ether acetate, sodium polyoxyethylene (EO 3 mol) lauryl ether acetate, and sodium polyoxyethylene (EO 3 mol) tridecyl ether acetate, among others.

The nonionic surfactant (C2) is not particularly restricted but is preferably a nonionic surfactant (C2-1) represented by the general formula (3).

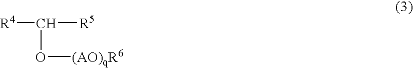

In the general formula (3), R⁴ represents an alkyl group containing 1 to 24 carbon atoms, and specific examples and preferred examples are the same as the alkyl groups mentioned above for R¹ and R².

In the general formula (3), R⁵ represents an alkyl group containing 1 to 5 carbon atoms (methyl, ethyl, propyl, isopropyl, butyl, pentyl groups). The preferred R⁵ is an alkyl group of 1 to 3 carbon atoms. R⁵ may be a mixture of 2 or more different species.

Referring to the general formula (3), R⁶ represents a hydrogen atom or an alkyl group containing 1 to 3 carbon atoms (methyl, ethyl, propyl, isopropyl groups). R⁶ may be a mixture of 2 or more species.

Referring, further, to the general formula (3), A has the same meaning as defined in general formula (1). (AO)_{q} in the general formula (3) is preferably an oxyethylene homopolymer group or an oxyethylene-oxypropylene block copolymer group, and from the standpoint of compatibility with the alkaline earth metal salt, the oxyethylene homopolymer group is particularly preferred.

In the general formula (3), q represents an integer of 1 to 10, preferably 1 to 6. Exceeding 10 tends to adversely affect the compatibility with the base oil.

The nonionic surfactant (C2-1) represented by general formula (3) there may be mentioned C3-33 secondary alcohol-EO and/or PO adducts. The nonionic surfactant (C2-1) is not particularly restricted, but there may be mentioned, for example, secondary alcohol(C13)-EO(3 mol) adduct, secondary alcohol(C13)-EO(5 mol) adduct, secondary alcohol(C13)-EO(7 mol) adduct, secondary alcohol(C13)-EO(9 mol) adduct, secondary alcohol(C15)-EO(3 mol) adduct, secondary alcohol(C15)-EO(5 mol) adduct, secondary alcohol (C1)-EO(5 mol) adduct, secondary alcohol (C18)-EO(5 mol) adduct, secondary alcohol(C24)-EO(5 mol) adduct, secondary alcohol(C18)-EO(3 mol)/PO(2 mol) block adduct, secondary alcohol(C24)-EO(5 mol)/PO(3 mol) block adduct, secondary alcohol(C24)-EO(5 mol) adduct, and secondary alcohol(C18)-EO(3 mol)/PO(2 mol) adduct.

Among the above-mentioned categories of surfactant (C), (C1-1), (C1-2) and (C2-1) are preferred and the anionic surfactants (C1-1) and (C1-2) are still more preferred.

These surfactants (C) may be used independently or as a mixture of 2 or more different surfactants.

The level of use of (C) in the lubricant of the invention is not particularly restricted but the lower limit is preferably 0.01 mass %, more preferably 0.05 mass %, particularly preferably 0.07 mass %. The upper limit is preferably 8 mass %, more preferably 5 mass %, and particularly preferably 4 mass %.

The formulating ratio of the C12-24 higher fatty acid metal salt (B) to the surfactant (C) is not particularly restricted but from the standpoint of stability of the lubricant, the upper limit is preferably 99/1, more preferably 97/3, particularly preferably 95/5. The lower limit is preferably 20/80, more preferably 50/50, particularly preferably 55/45.

Where necessary, the lubricant of the invention may contain a further component (D) in addition to (A), (B), and (C). The component (D) there may be mentioned, for example, an anti-tackiness component (D1) other than (B), a static dissipating component (D2), and other additive (D3). Furthermore, an auxiliary solvent (E), which will be described hereinafter, may also be formulated.

(D1) may be formulated in a supplemental amount up to the extent not impairing the performance of the lubricant for treating elastic fiber according to the invention and serves to increase the anti-tackiness effect.

(D1) there may be mentioned a silicone (D11) which is solid at room temperature, a polyether-modified silicone (D12), and a mixture of two or more different species of each. The term “solid at room temperature” as used herein means that the particular component is solid at 25° C.

The silicone (D11) which is solid at room temperature (25° C.) is not particularly restricted but there may be mentioned, for example, polyorganosiloxanes containing trifunctional siloxane units or tetrafunctional siloxane units within the molecule (silicone resins). Thus, for example, highly branched three-dimensional solid polymers [e.g. DT resins containing difunctional siloxane units (D units) and trifunctional siloxane units (T units) as dominant component units, MQ resins containing monofunctional siloxane units (M units) and quadrifunctional siloxane units (Q units) as dominant component units, and polyorganosilsesquioxanes consisting exclusively of T units].

The preferred are methylsilicone resins having weight average molecular weights (by gel permeation chromatography: briefly Mw) of 1,000 to 100,000 and amino-modified organopolysiloxane resins having Mw values of 1,000 to 100,000. The more preferred are methylsilicone resins having Mw values of 1,500 to 30,000.

The polyether-modified silicone (D12) is not particularly restricted but there may be mentioned, for example, the silicone represented by the following general formula (4) wherein at least one of R⁷, R⁸, R⁹, and R¹⁰ is a polyoxyalkylene chain-containing group. The remaining group or groups may be a methyl, C2-20 alkyl, phenyl, or C1-5 alkoxy groups.

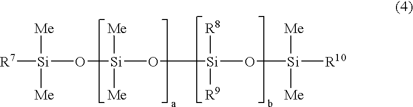

The polyoxyalkylene chain-containing group mentioned above is a group represented by the general formula:
-A¹-O-(A²-O)ₛ—R¹¹
(wherein R¹¹ represents a hydrogen atom or an alkyl group containing 1 to 30 carbon atoms; A¹ represents an alkylene group containing 1 to 5 carbon atoms; A² represents an alkylene group containing 1 to 4 carbon atoms, which may be the same or different and be block or random in a plurality of occurrences; s represents an integer of 1 to 100).

The formulating level of such (D1) in the lubricant of the invention is preferably not over 4 mass %, more preferably not over 2 mass %. Moreover, with respect to 100 mass parts of (B), the formulating level is preferably not over 200 mass parts, more preferably not over 100 mass parts.

As the antistatic component (D2), there may be mentioned the amphoteric surfactant (D21) and cationic surfactant (D22).

The amphoteric surfactant (D21) is not particularly restricted but any of betaine type amphoteric surfactant, amino acid type amphoteric surfactant, and sulfonic acid type amphoteric surfactant, for instance, can be used.

The betaine type amphoteric surfactant is not particularly restricted but there may be mentioned, for example, alkyl(C1-30)dimethylbetaine, alkyl(C1-30)amidoalkyl(C1-4)dimethylbetaine, alkyl(C1-30)dihydroxyalkyl(C1-30)betaine, and sulfobetaine amphoteric surfactants. The preferred, among these, are alkyldimethylbetaines and alkylamidoalkyldimethylbetaines.

The amino acid type amphoteric surfactant is not particularly restricted but there may be mentioned, for example, alanine type [alkyl(C1-30)aminopropionic acid type and alkyl(C1-30)iminodipropionic acid type] amphoteric surfactants and glycine type [e.g. alkyl(C1-30)aminoacetic acid type] amphoteric surfactants. The preferred, among these, are alkylaminopropionic acid type amphoteric surfactants and alkyliminodipropionic acid type amphoteric surfactants.

The sulfonate type amphoteric surfactant (aminosulfonic acid type amphoteric surfactant) is not particularly restricted but there may be mentioned alkyl(C1-30) taurine type amphoteric surfactants.

The cationic surfactant (D22) is not particularly restricted but may for example be a quaternary ammonium salt type cationic surfactant or an amine salt type cationic surfactant.

The quaternary ammonium salt type cationic surfactant is not particularly restricted but there may be mentioned, for example, alkyl(C1-30)trimethylammonium salt, dialkyl(C1-30)dimethylammonium salt, nitrogen ring-containing quaternary ammonium salt (e.g. cetylpyridinium chloride), poly(addition number of mols=2 to 15)oxyalkylene (C2-4) chain-containing quaternary ammonium salt, and alkyl(C1-30)amidoalkyl(C1-10)dialkyl(C1-4)methylammonium salt (e.g. stearamidoethyldiethylmethylammonium methosulfate) cationic surfactants. The preferred, among these, are alkyltrimethylammonium organic acid salts and, in particular, dialkyldimethylammonium organic acid salts.

The amine salt type cationic surfactants are not particularly restricted but, for example, surfactants obtainable by neutralizing tertiary amines with an inorganic acid (e.g. hydrochloric acid, nitric acid, sulfuric acid, or hydroiodic acid) or an organic acid (e.g. acetic acid, formic acid, oxalic acid, lactic acid, gluconic acid, adipic acid, or an alkylsulfuric acid) can be employed. Thus, for example, inorganic acid or organic acid salts of aliphatic tertiary amines containing 3 to 90 carbon atoms, alicyclic (inclusive of nitrogen-containing heterocyclic) tertiary amines containing 3 to 90 carbon atoms, and hydroxyalkyl group-containing tertiary amines containing 3 to 90 carbon atoms can be mentioned. The preferred, among these, are inorganic or organic acid salts of aliphatic amines.

The formulating level of said antistatic component (D2) in the lubricant of the invention is preferably 0 to 12 mass %, more preferably 0.1 to 10 mass %.

As said additive (D3) other than the foregoing components, additives which are conventionally used in lubricants for treating elastic fiber can be used, and oxidation inhibitors (hindered phenols, hindered amines, etc.), ultraviolet absorbers, etc. can be mentioned. The formulating level of (D3) in the lubricant of the invention is preferably not over 5 mass %, more preferably not over 2 mass %.

As the auxiliary solvent (E) there may be mentioned, for example, monohydric aliphatic alcohols [methanol, ethanol, propanol, butanol, pentyl alcohol, neopentyl alcohol, 2-ethylhexyl alcohol, etc.]; dihydric alcohols (ethylene glycol, propylene glycol, butylene glycol, etc.); aliphatic hydrocarbons such as hexane, pentane, etc.; ketones such as acetone, methyl ethyl ketone, methyl isobutyl ketone, etc.; aromatic hydrocarbons such as toluene, xylene, etc.; high-polar solvents such as dimethylformamide, dimethyl sulfoxide, etc.; and halogenated hydrocarbons such as chloroform, carbon tetrachloride and so forth.

It is to be understood that when a hydrocarbon series lubricating oil (A2) is used, it may be used as at least a partial constituent of the base oil (A). The auxiliary solvent (E) may be formulated as it is in the lubricant of the invention or when it is a removable one, for example (E3), it may be removed by stripping, for instance.

The technology of producing the lubricant of the invention there may be mentioned the following method as an example.

In the first place, (B), which is solid at room temperature, is placed, together with (C), in a vessel equipped with a stirring means and dissolved completely by heating to 100 to 150° C. in order to prepare a liquid mixture (I) composed of (B) and (C). This mixture is added to (A) adjusted to a temperature of −40° C. to 25° C. in advance, whereby (B) with a volume average particle diameter of 0.001 to 1.0 μm can be obtained. (I) may be a homogeneous solution or a dispersion.

The procedure for preparing said liquid mixture (I) is not particularly restricted but preferably comprises melting the mixture containing (B) and (C) by heating to 80 to 160° C.

(I) may be exclusively composed of (B) and (C) but may optionally be one prepared by melting said mixture further containing at least a portion of said hydrocarbon series lubricating oil (A2) or said auxiliary solvent (E) under heating.

After pouring (I) in (A), the whole mixture may be stirred at a peripheral speed of 40 to 10,000 m/min to thereby reduce the particle diameter of (B), thus contributing to the stability of the lubricant.

The dispersion obtained by the above method may be used as it is as the lubricant for treating elastic fiber according to the invention but may optionally be further supplemented with (A), (D) and the like, and the whole mixture may be used as the lubricant of the invention.

For uniform deposition and preventing roller wrap-up, the viscosity of the lubricant of the invention is preferably set to 2 to 100 mm²/s at 25° C.

The viscosity is measured by the following method.

A sample of the lubricant is placed in a 20 g Ubbelohde viscometer and the sample temperature is adjusted to 25±0.5° C. in a constant-temperature water bath. After 30 minutes, the viscosity is measured by the method of Ubbelohde.

As to the application mode of the lubricant, the lubricant may generally be used in an anhydrous form but, where necessary, be used in the form of an aqueous emulsion.

The use of the anhydrous form means the use of the lubricant as it is (straight lubrication) or the use thereof as diluted with a diluent (e.g. an organic solvent or a low-viscosity mineral oil). The dilution ratio is not particularly restricted but the mass of the lubricant [total mass of monovolatile matter] is generally 1 to 80 mass %, preferably 5 to 70 mass %, based on the total mass of the diluted lubricant.

The low-viscosity mineral oil mentioned above is not particularly restricted but there may be mentioned, for example, liquid paraffin and purified spindle oil whose viscosities at 25° C. are less than 1 mm²/s.

The aqueous emulsion mentioned above can be prepared by known emulsification techniques; for example, the lubricant of the invention is optionally mixed with an emulsifier in advance and then emulsified in water.

Depending on the types of (A) and (C), the emulsifier need not necessarily be added but said anionic surfactant and nonionic surfactant, for instance, can be used.

The level of use of the emulsifier other than the emulsifiers corresponding to the above respective components is preferably 0 to 50% based on the total mass of the lubricant (nonvolatile matter) after formulation with the emulsifier.

The emulsifying machine which can be used is not particularly restricted but there may be mentioned, for example, an emulsification tank equipped with a stirrer, a ball mill, a Gaulin homogenizer, a Homo-disper, and a bead mill.

The concentration of the emulsion is not particularly restricted but the mass of the lubricant is preferably 0.01 to 30 mass %, more preferably 0.2 to 20 mass %, based on the total mass of the emulsion obtained by the above emulsification.

The lubricant of the invention can be applied to fiber by the roller, nozzle or other lubricating technique in the elastic fiber spinning process (e.g. 200 to 1,200 m/min) in an arbitrary position downstream of the spinneret and upstream of the wind-up gear. The temperature of the lubricant to be fed is generally 10 to 80° C., preferably 15 to 60° C.

The level of deposition of the lubricant according to the invention is generally 0.1 to 12 mass % as the nonvolatile matter relative to the elastic fiber. The lower limit is preferably 0.5 mass %, more preferably 1 mass %, and the upper limit is preferably 10 mass %, more preferably 8 mass %.

The elastic fiber to which the lubricant of the invention can be applied there may be mentioned, for example, polyurethane elastic fiber, polyester elastic fiber, polyamide elastic fiber, and polycarbonate elastic fiber, although it can be applied to polyurethane elastic fiber with particular advantage.

The fineness of the elastic fiber to which the lubricant of the invention can be applied is not particularly restricted but is preferably 10 to 2500 dtx, more preferably 11 to 1870 dtx.

The elastic fiber treated with the lubricant of the invention is processed into end-products through various post-processing (e.g. air-spun yarn step, covering step, air-covering step, knitting step, warping step, scouring step, dyeing step, and finishing step). The elastic fiber can be blended with other synthetic fibers such as nylon and polyester fibers. Therefore, after application of the lubricant for treating elastic fiber according to the invention, the lubricant deposited is often removed together with the lubricant used for the other synthetic fiber in the scouring step. In the scouring step, aqueous scouring or melt scouring is carried out.

Referring to end-products, the invention can be applied broadly to clothing [e.g. pantyhoses, socks, inner foundation (brassieres, girdles, bodysuits, etc.), outerware (jackets, slacks, etc.), sportsware (swimsuits, leotards, ski pants, etc.), etc.] and industrial materials (e.g. paper diapers, belts, and so forth).

### BEST MODE FOR CARRYING OUT THE INVENTION

The following examples are further illustrative but by no means definitive of the present invention. All parts in the text and table are parts by mass (active substance).

### EXAMPLES 1 TO 4 AND COMPARATIVE EXAMPLES 1 TO 6

According to the recipes and conditions for production shown in Table 1, various components were formulated and processed to prepare lubricants for treating elastic fiber of the invention and Comparative Examples.

### Example 1

1 part of magnesium distearate, 0.1 parts of di-2-ethylhexyl sulfosuccinate sodium, and 10 parts of liquid paraffin were admixed at 110 to 120° C. to prepare a liquid mixture (I). A reaction vessel equipped with a stirrer was charged with 28.9 parts of liquid paraffin controlled at a temperature of 5° C. and, under stirring, (I) adjusted to 80 to 120° C. in advance was gradually fed to the vessel, followed by 30 minutes' stirring. The internal temperature of the vessel was 5 to 22° C. at this stage. Then, 60 parts of polydimethylsiloxane was fed to the vessel to prepare a lubricant according to Example 1.

### Example 2

Except that 1 part of magnesium distearate, 0.1 parts of isotridecyl alcohol-EO(3 mol) adduct carboxymethyl ether sodium, and 10 parts of liquid paraffin were admixed to prepare a liquid mixture (I), the procedure of Example 1 was otherwise faithfully followed to give a lubricant according to Example 2.

### Example 3

Except that 1 part of magnesium distearae, 0.5 parts of secondary alcohol(C13)-EO(5 mol) adduct, and110 parts of liquid paraffin were admixed to prepare a liquid mixture (I), the procedure of Example 1 was otherwise faithfully followed to give a lubricant according to Example 3.

### Example 4

Except that 1 part of calcium distearate, 0.1 parts of di-2-ethylhexyl sulfosuccinate sodium salt, and 10 parts of liquid paraffin were admixed to prepare a liquid mixture (I), the procedure of Example 1 was otherwise faithfully followed to give a lubricant according to Example 4.

### Comparative Example 1

Except that 1 part of magnesium distearate and 10 parts of liquid paraffin were admixed to prepare a liquid mixture (I), the procedure of Example 1 was otherwise faithfully followed to give a lubricant according to Comparative Example 1.

### Comparative Example 2

Except that 1 part of magnesium distearate, 0.1 parts of perfluorooctyl sulfonate sodium, and 10 parts of liquid paraffin were admixed to prepare a liquid mixture (I), the procedure of Example 1 was otherwise faithfully followed to give a lubricant according to Comparative Example 2. The SP value of perfluorooctyl sulfonate sodium used in this Comparative Example was 7.2, which is too low.

### Comparative Example 3

Except that 1 part of magnesium distearate, 0.1 parts of lauric monoethanolamide-EO(2 mol) adduct, and 10 parts of liquid paraffin were admixed to prepare a liquid mixture (I), the procedure of Example 1 was otherwise faithfully followed to give a lubricant according to Comparative Example 3. The SP value of lauric monoethanolamide-EO(2 mol) adduct used in this Comparative Example was 10.7, which is too high.

### Comparative Example 4

Except that 1 part of magnesium distearate was omitted from the recipe, the procedure of Example 1 was otherwise faithfully followed to give a lubricant according to Comparative Example 4.

### Comparative Example 5

Except that 1 part of potassium stearate was used in lieu of magnesium distearate, the procedure of Example 1 was otherwise faithfully followed to give a lubricant according to Comparative Example 5.

### Comparative Example 6

1 part of magnesium distearate, 0.1 parts of di-2-ethylhexyl sulfosuccinate sodium, 38.9 parts of liquid paraffin, and 60 parts of dimethylpolysiloxane were admixed in one operation and heated for dissolving at 110 to 120° C. Then, under stirring, the mixture was cooled to 20° C. at a rate of 10° C./hr. to give a lubricant according to Comparative Example 6.

In the dry spinning process for the production of polyurethane elastic fiber, each lubricant shown in Table 1 was applied by the roller lubricating technique in a deposition amount of 6 mass % based on the mass of elastic fiber and the lubricated fiber was taken up into a cheese form at a rate of 600 m/min to give a 40D polyurethane fiber.

In addition, each lubricant was subjected to the aging stability test and anti-tackiness test. The results of these performance evaluations are also shown in Table 1. The volume average particle diameter of (B) component in each lubricant is also shown in Table 1.

TABLE 1

| Example | | | | Comparative Example | | | | | |
|---|---|---|---|---|---|---|---|---|---|
| 1 | 2 | 3 | 4 | 1 | 2 | 3 | 4 | 5 | 6 |

<Recipe>

| | | | | | | | | | | |
|---|---|---|---|---|---|---|---|---|---|---|
| Dimethylpolysiloxane | 60 parts | 60 | 60 | 60 | 60 | 60 | 60 | 60 | 60 | 60 |
| Liquid paraffin | 38.9 | 38.9 | 38.5 | 38.9 | 39.0 | 38.9 | 38.9 | 39.9 | 38.9 | 38.9 |
| Magnesium distearate | 1 | 1 | 1 | | 1 | 1 | 1 | | | 1 |
| Calcium distearate | | | | 1 | | | | | | |
| Potassium stearate | | | | | | | | | 1 | |
| Surfactant-1 (SP = 9.6) | 0.1 | | | 0.1 | | | | 0.1 | 0.1 | 0.1 |
| Surfactant-2 (SP = 8.1) | | 0.1 | | | | | | | | |
| Surfactant-3 (SP = 9.7) | | | 0.5 | | | | | | | |
| Surfactant-4 (SP = 7.2) | | | | | | 0.1 | | | | |
| Surfactant-5 (SP = 10.7) | | | | | | | 0.1 | | | |

<Performance characteristic evaluation>

| Volume average particle | | 0.3 | 0.3 | 0.4 | 0.8 | 2.1 | 2.0 | 2.0 | — | 0.3 | 2.0 |
|---|---|---|---|---|---|---|---|---|---|---|---|
| diameter (μm) | | | | | | | | | | | |
| Aging stability of | −5° C. | ◯ | ◯ | ◯ | ◯ | X | X | X | ◯ | ◯ | X |
| lubricant | 25° C. | ◯ | ◯ | ◯ | ◯ | X | X | X | ◯ | ◯ | X |
| | 50° C. | ◯ | ◯ | ◯ | ◯ | X | X | X | ◯ | ◯ | X |

| | | | | | | | | | | |
|---|---|---|---|---|---|---|---|---|---|---|
| Anti-tackiness | ◯ | ◯ | ◯ | ◯ | ◯ | ◯ | ◯ | X | X | ◯ |
| characteristic | | | | | | | | | | |

The method for measurement of the volume average particle diameter of (B) component in the lubricant according to each of the foregoing Examples and Comparative Examples, the protocol for aging stability test of the lubricant and the protocol for anti-tackiness test of lubricated fiber are as follows.

<Method for Measurement of Volume Average Particle Diameter>

The lubricant was put into a 10 mm-long cell and the diameter was measured by the dynamic light scattering method using ELS-800 manufactured by Otsuka Electronics Co., Ltd.

<Aging Stability Test of Lubricant>

100 g of the prepared lubricant was put in a glass bottle of 145 ml capacity and allowed to stand in an incubator at −5° C., 25° C. or 50° C. for 30 days. The appearance of the lubricant was then visually examined, compared with the appearance of the lubricant immediately after preparation, and evaluated according to the following criteria.

Evaluation Criteria
O: no change
X: separation and/or sedimentation
   <Anti-Tackiness Test>

The cheese obtained in the spinning stage was subjected to 1-week-long aging at 25° C. and the aged fiber was supplied to an unwind/wind-up device with a variable speed ratio function (the ratio of wind-up speed/unwind speed is variable). The fiber was paid out at a rate of 50 m/min and the minimum speed ratio in which the fiber could be taken up without wrap-up by tackiness was determined. The anti-tackiness effect was evaluated according to the following criteria.

Evaluation Criteria
O: speed ratio=50 to 65
X: speed ratio>66

The particulars of the components shown in Table 1 are as follows.
Polydimethylsiloxane: KF96-10CS (viscosity: 10 mm²/s (25° C.)) (product of Shin-Etsu Chemical Co., Ltd.)
Liquid paraffin: Liquid Paraffine 60S (viscosity: 15 mm²/s (25° C.) (product of Sanko Chemical Co., Ltd.)
Surfactant-1: di-2-ethylhexyl sulfosuccinate sodium
Surfactant-2: isotridecyl alcohol-EO(3 mol) adduct carboxymethyl ether sodium
Surfactant-3: secondary alcohol(C13)-EO(5 mol) adduct
Surfactant-4: perfluorooctyl sulfonate sodium
Surfactant-5: lauric monoethanolamide-EO(2 mol) adduct

It will be apparent from Table 1 that the lubricants prepared by using surfactants with SP values within the defined range according to the invention and having volume average particle diameters in the defined range (Examples 1 to 4) are excellent in both the aging stability and anti-tackiness characteristic of the lubricants. In contrast, none of the lubricants according to Comparative Examples 1 to 6 satisfy all the performance evaluation parameters.

### INDUSTRIAL APPLICABILITY

In the manufacture of elastic fiber using the lubricant for treating elastic fiber according to the invention, the outstanding aging stability and preventive effect against thread-to-thread tackiness of the lubricant enable manufacture of elastic fiber with long-run stability of operation throughout the whole process from the spinning stage to the post-processing stage.

1. A lubricant for treating elastic fiber which comprises
at least 80 mass % of at least one base oil (A) having a viscosity at 25° C. of 1 to 1,000 mm²/s as selected from the group consisting of silicone oil (A1) and hydrocarbon series lubricating oil (A2),
0.05 to 2 mass % of a C12 to 24 higher fatty acid alkaline earth metal salt (B) having a volume average particle diameter of 0.001 to 1 μm, and
0.01 to 8 mass % of at least one surfactant (C) having a solubility parameter (SP value) of 8.0 to 10.5 as selected from the group consisting of anionic surfactant (C1) and nonionic surfactant (C2).

2. The lubricant for treating elastic fiber according to claim 1
wherein the surfactant (C) is at least one member selected from the group consisting of the sulfosuccinic ester anionic surfactant (C1-1) represented by the following general formula (1), the ethercarboxylic acid anionic surfactant (C1-2) represented by the following general formula (2), and the nonionic surfactant (C2-1) represented by the following general formula (3). 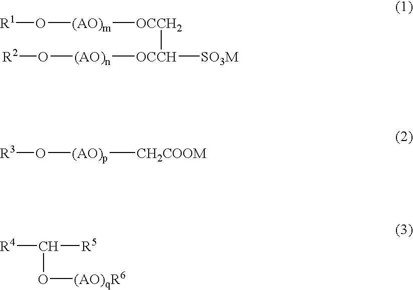
in the above formulas, R¹, R² and R³ each independently represents a group selected from the group consisting of alkyl groups containing 1 to 24 carbon atoms and alkenyl groups containing 2 to 24 carbon atoms; R⁴ represents an alkyl group containing 1 to 24 carbon atoms; R⁵ represents an alkyl group containing 1 to 5 carbon atoms; R⁶ represents a hydrogen atom or an alkyl group of 1 to 3 carbon atoms; A represents an alkylene group containing 2 to 4 carbon atoms; m represents an integer of 0 to 10; n represents an integer of 0 to 10; provided, however, that m+n is an integer of 0 to 10; p represents an integer of 0 to 10; q represents an integer of 1 to 10; M represents a hydrogen atom, an alkali metal atom, or a substituted or unsubstituted ammonium group.

3. The lubricant for treating elastic fiber according to claim 1 or 2
wherein the ratio by mass of alkaline earth metal salt (B) to surfactant (C) is 99/1 to 20/80.

4. The lubricant for treating elastic fiber according to claim 1 or 2
wherein alkaline earth metal salt (B) is magnesium distearate.

5. The lubricant for treating elastic fiber according to claim 1 or 2
wherein silicone oil (A1) is an unsubstituted polydimethylsiloxane and/or a substituted polydimethylsiloxane as substituted by a group selected from the class consisting of an alkyl group containing 2 to carbon atoms and a phenyl group.

6. The lubricant for treating elastic fiber according to claim 1 or 2
wherein the hydrocarbon series lubricating oil (A2) is a mineral oil or a purified, hydrogenated or cracked mineral oil.

7. The lubricant for treating elastic fiber according to claim 1 or 2
wherein the volume average particle size of alkaline earth metal salt (B) is 0.01 to 0.5 μm.

8. A method of treating elastic fiber
which comprises applying 0.1 to 12 mass % of the lubricant for treating elastic fiber according to claim 1 or 2 to elastic fiber in its spinning stage, optionally followed by scouring.

9. An elastic fiber
which is treated by the method according to claim 8.
